(19) United States
(12) Patent Application Publication
(10) Pub. No.: US 2025/0263064 A1
(43) Pub. Date: Aug. 21, 2025

(54) HYBRID VEHICLE

(71) Applicant: ISUZU MOTORS LIMITED, Yokohama-shi (JP)

(72) Inventor: Sei KAMAKURA, Fujisawa-shi (JP)

(21) Appl. No.: 19/047,954

(22) Filed: Feb. 7, 2025

(30) Foreign Application Priority Data
Feb. 19, 2024 (JP) 2024-022816

(51) Int. Cl. B60W 20/15; B60W 10/06; B60W 10/08; B60W 30/18

(52) U.S. Cl. CPC B60W 20/15; B60W 10/06; B60W 10/08; B60W 30/18118; B60W 2540/10; B60W 2552/15; B60W 2710/0677; B60W 2710/086

(57) ABSTRACT

A hybrid vehicle includes an engine and a motor as drive sources, and including a detection part that detects a start timing at which the hybrid vehicle passes through a start position of an uphill slope, and an output control part that increases an output of the engine and decreases an output of the motor as the time elasped from the start timing increases.

### CROSS-REFERENCE TO RELATED APPLICATIONS

The present application claims priority to Japanese Patent Application number 2024-022816, filed on Feb. 19, 2024, contents of which are incorporated herein by reference in its entirety.

### BACKGROUND OF THE INVENTION

The present disclosure relates to a hybrid vehicle. In a conventional hybrid electric vehicle, a NOx purification rate of a catalyst is improved by controlling the magnitude of motor output and engine output on the basis of the temperature of the catalyst for purifying NOx contained in the exhaust gas and the load required for the hybrid electric vehicle (for example, Japanese Unexamined Patent Application Publication No 2014-227888).

The catalyst reduces NOx emissions by adsorbing ammonia, which is contained in urea water injected into the exhaust gas, and reacting NOx contained in the exhaust gas with the ammonia to reduce NOx to nitrogen and water. The catalyst has the characteristic that the amount of ammonia it can adsorb decreases as the temperature increases. Therefore, when the engine output rapidly increases due to a change in the gradient of the road during travel, the temperature of the catalyst also rises sharply along with the rapid rise in the exhaust gas temperature, causing ammonia to be desorbed from the catalyst and emitted.

### BRIEF SUMMARY OF THE INVENTION

The present disclosure has been made in view of these points, and its object is to suppress the emission of ammonia.

A hybrid vehicle according to an aspect of the present disclosure includes an engine and a motor as drive sources, the hybrid vehicle including: a detection part that detects a start timing at which the hybrid vehicle passes through a start position of an uphill slope; and an output control part that increases an output of the engine and decreases an output of the motor as a time elapsed from the start timing increases.

### BRIEF DESCIRPTION OF THE DRAWINGS

FIG. 1 illustrates an outline of a hybrid vehicle S according to the present embodiment.

FIG. 2 illustrates an output of an engine 6 and an output of a motor 4.

FIG. 3 shows changes in engine output and motor output in a time period PO.

FIG. 4 shows an example of a processing sequence in a power determination apparatus 20.

FIG. 5 shows an operation of correcting a ratio of the outputs of the engine 6 and the motor 4.

### DETAILED DESCRIPTION OF THE INVENTION

Hereinafter, the invention will be described through embodiments of the invention. The below embodiments, however, are not intended to limit the invention according to the claims, and all combinations of features described in the embodiments are not necessarily essential to the solutions of the invention.

### Outline of a Hybrid Vehicle S

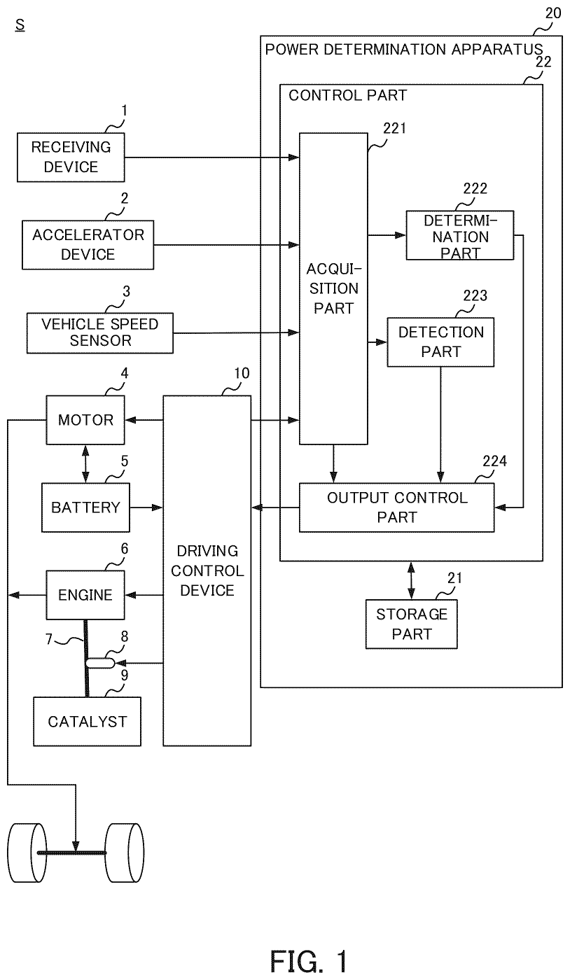

FIG. 1 illustrates an outline of a hybrid vehicle S (hereinafter, referred to as a “vehicle S”) according to the present embodiment. The vehicle S shown in FIG. 1 includes a receiving device 1, an accelerator device 2, a vehicle speed sensor 3, a motor 4, a battery 5, an engine 6, an exhaust passage 7, an injection device 8, a catalyst 9, a driving control device 10, and a power determination apparatus 20. The vehicle S has a function of determining the output of the motor 4 and the engine 6 that are provided as drive sources, causes the motor 4 to generate torque corresponding to the determined output of the motor 4, and causes the engine 6 to inject fuel into the engine 6 at a fuel injection quantity corresponding to the determined output of the engine 6.

The receiving device 1 identifies the position and travel route of the vehicle S on the basis of information included in radio waves received from a Global Navigation Satellite System (GNSS) and map information stored in the receiving device 1, and is, for example, a car navigation system. For example, the receiving device 1 identifies the position and travel route of the vehicle S, as well as the start position, distance, and angle of an uphill slope in the travel route, at a predetermined control cycle, and outputs them to the power determination apparatus 20. The control cycle is, for example, 0.1 seconds.

The accelerator device 2 is a device for controlling acceleration of the vehicle S. The accelerator device 2 includes, for example, an accelerator pedal and a pedal sensor. The pedal sensor detects a pedal depression amount that indicates an amount that a driver of the vehicle S steps on the accelerator pedal. The accelerator device 2 outputs the detected pedal depression amount as an accelerator opening degree to the power determination apparatus 20. The vehicle speed sensor 3 detects a vehicle speed of the vehicle S and outputs the vehicle speed to the power determination apparatus 20.

The motor 4 is the drive source of the vehicle S, and is an electric motor that generates power by electricity supplied from the battery 5 via an inverter (not shown). When braking the vehicle S, the motor 4 may cause the battery 5 to store electricity generated by operating as a generator (so-called regenerative braking). The battery 5 is a power storage device that supplies electricity to the motor 4, and includes a rechargeable storage battery. The battery 5 stores, for example, electricity supplied from external source of the vehicle S, electricity generated by the motor 4, and electricity generated by a solar panel (not shown) included in the vehicle S.

The engine 6 is the drive source of the vehicle S, and is an internal combustion engine that generates power by combustion and expansion of a mixture of fuel and intake air (air). The exhaust passage 7 is a passage through which exhaust gas from the engine 6 flows to the catalyst 9. The injection device 8 is provided downstream of the engine 6 and upstream of the catalyst 9 in the exhaust passage 7, injects urea water into the exhaust gas flowing through the exhaust passage 7, and includes a urea water injector that injects the urea water.

The catalyst 9 is a device that is provided downstream of the engine 6 and the injection device 8 in the exhaust passage 7 and purifies the exhaust gas flowing through the exhaust passage 7, and includes, for example, a Selective Catalytic Reduction (SCR). The catalyst 9 purifies NOx by, for example, adsorbing ammonia, which is contained in the urea water injected by the injection device 8, and reacting NOx contained in the exhaust gas flowing through the exhaust passage 7 with the ammonia to generate water and nitrogen.

The driving control device 10 is, for example, a device including a processor such as a Central Processing Unit (CPU) or an Electronic Control Unit (ECU) and a storage part, and executes various processes by having the processor execute programs stored in the storage part. For example, the driving control device 10 causes the engine 6 to inject fuel with a fuel injection quantity corresponding to the engine output determined by the power determination apparatus 20 and causes the motor 4 to generate a motor torque corresponding to the motor output determined by the power determination apparatus 20. For example, the driving control device 10 acquires a state of charge (SOC) of the battery 5 and provides notification about the state of charge to the power determination apparatus 20.

The power determination apparatus 20 is, for example, a device including a processor such as the CPU or the ECU. The power determination apparatus 20 executes processes such as (i) determining the output of the motor 4 and the output of the engine 6 on the basis of, for example, the accelerator opening degree acquired from the accelerator device 2 and the vehicle speed acquired from the vehicle speed sensor 3, and (ii) providing notification about each determined output to the driving control device 10. The power determination apparatus 20 may have a housing including electronic components, or may be a printed substrate on which the electronic components are mounted. The power determination apparatus 20 may include the driving control device 10.

The maximum amount of ammonia that can be adsorbed by the catalyst 9 decreases as the temperature of the catalyst 9 increases. Therefore, for example, when the road on which the vehicle S is traveling changes from a flat road to a road with an uphill slope, the output of the engine 6 rapidly increases. This causes the catalyst temperature to rise rapidly along with the rapid rise in the exhaust gas temperature, resulting in a rapid decrease in the maximum amount of ammonia that can be adsorbed by the catalyst 9. As a result, in the catalyst 9, because the amount of ammonia adsorbed before the catalyst temperature rises exceeds the maximum amount of ammonia that can be adsorbed after the catalyst temperature rises, ammonia may desorb from the catalyst 9, resulting in a phenomenon known as ammonia slip.

Therefore, in traveling after passing the start position of the uphill slope, the power determination apparatus 20 increases the output of the engine 6 and decreases the output of the motor 4 as an elapsed time from the timing at which the start position was passed increases. For example, the power determination apparatus 20 gradually increases a ratio of the output of the engine 6 and gradually decreases a ratio of the output of the motor 4 among the outputs based on the accelerator opening degree and the vehicle speed, as the elapsed time increases. By operating in this manner, the power determination apparatus 20 can suppress a rapid rise in the temperature of the catalyst 9 due to a rapid increase in the output of the engine 6 during traveling on the road with the uphill slope, thereby suppressing the occurrence of ammonia slip. Hereinafter, the configuration and operation of the power determination apparatus 20 will be described in detail.

### Configuration of the Power Determination Apparatus 20

As shown in FIG. 1, the power determination apparatus 20 includes a storage part 21 and a control part 22. The control part 22 includes an acquisition part 221, a determination part 222, a detection part 223, and an output control part 224.

The storage part 21 includes, for example, a storage medium such as a Read Only Memory (ROM), a Random Access Memory (RAM), a Hard Disk Drive (HDD), or a Solid State Drive (SSD). The storage part 21 stores programs executed by the control part 22 and various types of information for determining the output of the motor 4 and the output of the engine 6. As an example, the storage part 21 stores a first output map that indicates the output of the motor 4 and the output of the engine 6 corresponding to the accelerator opening degree and the vehicle speed, and a second output map that indicates the output of the vehicle S corresponding to the accelerator opening degree. In the first output map, a greater output corresponds to a greater accelerator opening degree, and a greater output corresponds to a greater vehicle speed. In the second output map, a greater output corresponds to a greater accelerator opening degree.

The control part 22 is, for example, a processor such as a CPU or an ECU. The control part 22 functions as the acquisition part 221, the determination part 222, the detection part 223, and the output control part 224 by executing the programs stored in the storage part 21. The control part 22 may be configured with a single processor, or may be configured with a plurality of processors or a combination of one or more processors and an electronic circuit. The configuration of each unit implemented by the control part 22 will be described below.

The acquisition part 221 acquires various types of information from an external source of the power determination apparatus 20 at a predetermined control cycle. For example, the acquisition part 221 acquires, from the receiving device 1, information including the position of the vehicle S, the travel route of the vehicle S, as well as the start position, distance, and angle of the uphill slope in the travel route. For example, the acquisition part 221 acquires the depression amount of the accelerator pedal as the accelerator opening degree from the accelerator device 2. For example, the acquisition part 221 acquires the SOC of the battery 5 from the driving control device 10. The acquisition part 221 acquires, for example, the vehicle speed of the vehicle S from the vehicle speed sensor 3. The acquisition part 221 stores the acquired various types of information in the storage part 21.

The determination part 222 determines whether the vehicle S will travel on an uphill slope at a time after the current time. For example, the determination part 222 determines whether an uphill slope exists ahead in the vehicle S's traveling direction on the basis of the position of the vehicle S, the traveling route of the vehicle S, and the start position of the uphill slope in the traveling route, which are acquired by the acquisition part 221. When determining that the uphill slope exists, the determination part 222 determines that the vehicle S will travel on the uphill slope when no branch point of the road exists between the position of the vehicle S and the start position of the uphill slope at a time prior to the timing at which the vehicle S passes through the start position of the uphill slope. The branch point refers to, for example, an intersection or a branch road on an ordinary road, a branch road leading to a junction on a highway, or a branch road leading to a parking space on a highway.

For example, when determining that the uphill slope exists and the branch point of the road exists between the position of the vehicle S and the start position of the uphill slope, the determination part 222 determines that there is a possibility that the vehicle S will not travel on an uphill slope. For example, when determining that no uphill slope exists, the determination part 222 determines that the vehicle S will not travel on an uphill slope. By operating as described above, the determination part 222 enables the output control part 224 to determine the outputs of the motor 4 and the engine 6 on the basis of whether the vehicle S will travel on the uphill slope at a time after the time before the vehicle S passes through the start position of the uphill slope.

The detection part 223 detects a start timing at which the vehicle S passes through the start position of the uphill slope. For example, the detection part 223 detects, as the start timing, a timing at which a subtraction value, obtained by subtracting a second accelerator opening degree at a time prior to the current time by the predetermined control cycle from a first accelerator opening degree at the current time, is equal to or greater than a predetermined value. The predetermined value is a value determined through experiment or simulation and is stored in the storage part 21. The detection part 223 may also detect, as the start timing, a timing at which the start position of the gradient changes from being ahead of the traveling direction of the position of the vehicle S to being behind the traveling direction of the position of the vehicle S in the traveling route of the vehicle S.

The detection part 223 may detect an end timing at which the vehicle S has passed through an end position of the uphill slope. For example, the detection part 223 detects, as the end timing, a timing at which a subtraction value, obtained by subtracting the first accelerator opening degree at the current time from the second accelerator opening degree at a time prior to the current time by the predetermined control cycle, is equal to or greater than a predetermined value. The detection part 223 may also detect, as the end timing, a timing at which the end position of the gradient changes from being ahead of the traveling direction of the position of the vehicle S to being behind the traveling direction of the position of the vehicle S on the traveling route of the vehicle S.

The output control part 224 determines the output of the motor 4 and the output of the engine 6, and provides notification about each determined output to the driving control device 10. By having the output control part 224 provide notification about each output in this manner, the driving control device 10 causes the motor 4 to generate motor torque corresponding to the notified output of the motor 4 and causes the engine 6 to inject fuel at a fuel injection quantity corresponding to the notified output of the engine 6.

When the determination part 222 determines that the vehicle S will not travel on an uphill slope, the output control part 224 identifies an output (hereinafter, referred to as a “required output”) corresponding to the driving force required of the vehicle S, on the basis of the accelerator opening degree and the vehicle speed acquired by the acquisition part 221. The output control part 224 identifies the required output corresponding to the accelerator opening degree and the vehicle speed by referencing the storage part 21, for example. Then, for example, the output control part 224 determines the output to be generated by the motor 4 and the output to be generated by the engine 6 from among the identified required outputs by referencing a power distribution map N1, which indicates the ratio between the output of the motor 4 and the output of the engine 6 in the required output and is stored in the storage part 21. The power distribution map N1 will be described later.

When the determination part 222 determines that the vehicle S will travel on the uphill slope, the output control part 224 increases the output of the engine 6 and decreases the output of the motor 4 at a time after the start timing detected by the detection part 223 as the time elapsed from the start timing increase. As an example, the output control part 224 includes a timer that counts the time elapsed from the point at which the detection part 223 detected the start timing, and increases the output of the engine 6 and decreases the output of the motor 4 according to the magnitude of a count value indicated by the timer. Details regarding the operation of the output control part 224 during the period from the timing determined by the determination part 222 to the start timing, when it determines that the vehicle S will travel on the uphill slope, will be described later.

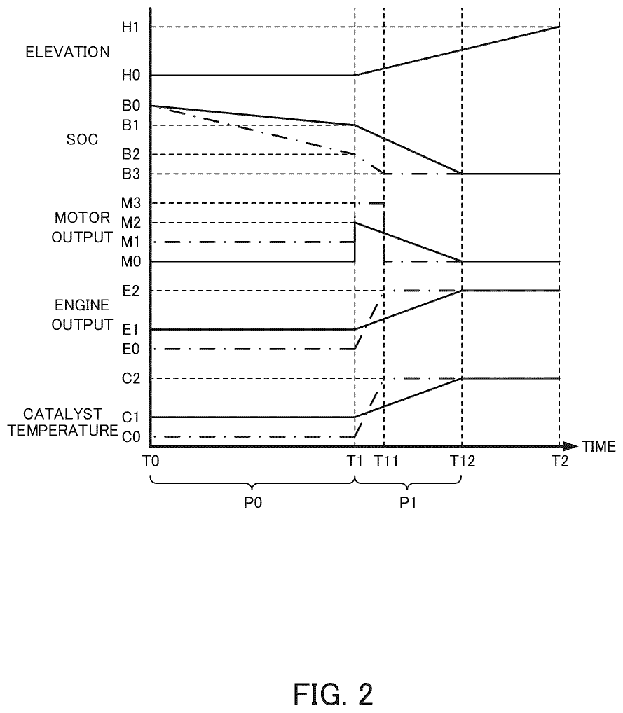

FIG. 2 illustrates the output of the engine 6 and the output of the motor 4. The horizontal axis in FIG. 2 represents time, and the vertical axis in FIG. 2 represents the “elevation” of the road on which the vehicle S is traveling, the “SOC” of the battery 5, the “motor output” generated by the motor 4, the “engine output” generated by the engine 6, and the “catalyst temperature” of the catalyst 9. A time T0 shown in FIG. 2 is a time indicating a determination timing at which the determination part 222 determines that the vehicle S will travel on the uphill slope, and a time T1 is a time indicating the start timing at which the vehicle S has passed through the start position of the uphill slope. In the following description, the determination timing is referred to as “Time T0,” and the start timing is referred to as “time T1”. In “SOC,” “motor output,” “engine output,” and “catalyst temperature” in FIG. 2, a solid line indicates the operation of the vehicle S according to the present embodiment, and a dashed line indicates the operation of a vehicle S of a comparative example.

As shown in FIG. 2, the vehicle S of the comparative example increases the engine output from an output E0 to an output E2 and sets the motor output to an output M3 in a time period from the time T1 to a time T11, which is shorter than a time period P1. With such an operation, although the vehicle S can generate an output corresponding to the required driving force, the catalyst temperature rapidly rises from a temperature C0 to a temperature C2, so that ammonia slip tends to occur easily.

In contrast, in the vehicle S according to the present embodiment, the output control part 224 increases the output of the engine 6 from an output E1 to the output E2 and decreases the output of the motor 4 from an output M2 to an output M0 as the elapsed time from the time T1 increases in the time period P1 from the time T1 to the time T12. By operating in this manner, the output control part 224 can gradually increase the engine output from the time T1 to the time T12 while generating the output corresponding to the required driving force of the vehicle S. As a result, since the output control part 224 can suppress the rapid rise in the temperature of the catalyst 9 as indicated by the “catalyst temperature” indicated by the dashed line in the time period from the time T1 to the time T11, it is possible to suppress desorption and emission of ammonia from the catalyst 9.

For example, the output control part 224 identifies the output corresponding to the accelerator opening degree by referencing the storage part 21, and increases the output of the engine 6 by a predetermined change amount, taking the output corresponding to the accelerator opening degree as the maximum value, at the time elapsed from the time T1. Then, the output control part 224 reduces the output of the motor 4 by the predetermined change amount so that, for example, the output obtained by subtracting the output of the engine 6 from the output corresponding to the accelerator opening degree becomes the output of the motor 4.

Specifically, in the time period P1, the output control part 224 increases the output of the engine 6 from the output E1 to the output E2 with a constant change amount, with the output E2 corresponding to the accelerator opening degree (that is, an additional value of the output E1 and the output M2) as the maximum value. Then, the output control part 224 reduces the output of the motor 4 from the output M2 to the output M0 (for example, 0) by the constant change amount so that a subtraction value obtained by subtracting the output of the engine 6 from the output E2 becomes the output of the motor 4.

By operating as described above, the output control part 224 can adjust the amount of change in the output of the engine 6 and the amount of change in the output of the motor 4 to equal change amounts. Thus, the output control part 224 can change the outputs of the engine 6 and the motor 4 at a constant ratio while generating the output corresponding to the accelerator opening degree. Furthermore, by reducing the predetermined change amount, the output control part 224 can gradually increase the output of the engine 6 and gradually decrease the output of the motor 4.

The output control part 224 may determine the predetermined change amount on the basis of (i) the SOC of the battery 5 that supplies electricity to the motor 4 and (ii) the angle of the uphill slope, both at the time T1. For example, the output control part 224 reduces the predetermined change amount as the angle of the uphill slope acquired by the acquisition part 221 at the time T1 increases. By operating in this manner, the output control part 224 can gradually decrease the output of the motor 4 while gradually increasing the output of the engine 6, even on a steep uphill slope that requires a large output. As a result, the output control part 224 can suppress the rapid rise in the catalyst temperature, thereby suppressing desorption and emission of ammonia from the catalyst 9.

For example, the output control part 224 reduces the predetermined change amount as the SOC of the battery 5 acquired by the acquisition part 221 at the time T1 increases. By operating in this manner, as the SOC increases, the output control part 224 increases the electricity consumption of the motor 4, which gradually decrease the output of the motor 4. By this, the output control part 224 can gradually increase the output of the engine 6.

Furthermore, the output control part 224 may determine the predetermined change amount so that the SOC is reduced to 0 while the vehicle S travels on the uphill slope. For example, the output control part 224 determines the predetermined change amount so that the SOC is reduced to 0 (SOC B3 shown in FIG. 2) during the time period from the time T1 to the time T2 shown in FIG. 2. By operating in this manner, the output control part 224 can facilitate a gradual increase in the output of the engine 6. Furthermore, as the SOC decreases, the battery 5 can more effectively store electricity generated by the motor 4 through regenerative braking when the vehicle S, having passed through the end position of the uphill slope, travels on a downhill slope and executes regenerative braking.

It should be noted that the output control part 224 may determine the predetermined change amount so that the SOC is reduced to a predetermined value while the vehicle S travels on an uphill slope. The predetermined value is a value greater than 0, and is the SOC for the battery 5 to supply electricity to other devices different from the motor 4. By operating in this manner, the output control part 224 can facilitate a gradual increase of the output of the engine 6 while operating each device to which the battery 5 supplies electricity.

In order to gradually decrease the motor output at a time after the time T1, the motor output needs to be large at the time T1. Furthermore, in order to gradually increase the engine output after the time T1, it is necessary to minimize the amount of change in the engine output from a time before the time T1 to the time T1. Therefore, the output control part 224 determines the engine output and the motor output so that the engine output does not sharply increase at the time T1, which is the start timing of passing through the start position of the uphill slope.

The output control part 224 determines the output of the engine 6 and the output of the motor 4 at the time T1 on the basis of, for example, (i) the average output of the engine 6 in the time period from the time prior to the time T1 by a predetermined time to the time T1 and (ii) the accelerator opening degree at the time T1. The predetermined time is a time determined through experiment or simulation, and is, for example, 1 second.

Specifically, at the time T1, the output control part 224 calculates an average output E1 of the output of the engine 6 determined to be a time period from one second before the time T1 to the time T1. Then, for example, the output control part 224 determines the average output E1 as the output of the engine 6 at the time T1, and determines the output M2 obtained by subtracting the average output E1 from an output E2 corresponding to the accelerator opening degree at the time T1 as the output of the motor 4 at the time T1.

By operating in this manner, the output control part 224 can increase the output of the motor 4 while ensuring the output of the engine 6 does not increase, all the while generating the output E2 corresponding to the accelerator opening degree at the time T1. As a result, the output control part 224 can gradually increase the output of the engine 6 while gradually decreasing the output of the motor 4 at the time after the time T1.

In order to increase the output of the motor 4 at the time T1 and gradually decrease the output of the motor 4 at the time after the time T1, the vehicle S needs to travel so to prevent the SOC of the battery 5 from decreasing at the time prior to the time T1. Therefore, the output control part 224 increases the output of the engine 6 at the output corresponding to the driving force required of the vehicle S and decreases the output of the motor 4 in a state where the vehicle S is traveling ahead of the uphill slope.

For example, the output control part 224 causes the engine 6 to generate a first correction output obtained by adding the correction amount to the output of the engine 6 corresponding to the accelerator opening degree and the vehicle speed at a time prior to the time T1 as a result of the determination part 222 determining that the vehicle S will travel on the uphill slope. Then, the output control part 224 causes the motor 4 to generate a second correction output obtained by subtracting the correction amount from the output of the motor 4 corresponding to the accelerator opening degree and the vehicle speed at a time prior to the time T1, for example, as a result of the determination part 222 determining that the vehicle S will travel on the uphill slope.

Specifically, the output control part 224 causes the engine 6 to generate the first correction output E1 obtained by adding the correction amount to the output E0 of the engine 6 corresponding to the accelerator opening degree and the vehicle speed in the time period P0 from the time T0 to the time T1 as shown in FIG. 2. Then, in the time period P0, the output control part 224 causes the motor 4 to generate the second correction output M0 obtained by subtracting the correction amount from an output M1 of the motor 4 corresponding to the accelerator opening degree and the vehicle speed. By operating in this manner, the output control part 224 can adjust the SOC of the battery 5 at the time T1 to an SOC B1 which is larger than the SOC B2, and thus can suppress a decrease in the SOC of the battery 5.

The output control part 224 determines the correction amount on the basis of, for example, the angle and distance of the uphill slope, and the SOC of the battery 5, which are acquired by the acquisition part 221. For example, the steeper the angle of the uphill slope, the more the output control part 224 increases the correction amount. By operating in this manner, the output control part 224 can reduce the decrease in the SOC at a time prior to the time T1 to a smaller extent as the slope becomes steeper. As a result, the steeper the uphill slope, the more the output control part 224 can increase the amount of electricity to be supplied to the motor 4 at the time after the time T1. This enables the output control part 224 to gradually decrease the output of the motor 4.

For example, the longer the distance of the uphill slope, the more the output control part 224 increases the correction amount. By operating in this manner, the output control part 224 can reduce the decrease in the SOC at a time prior to the time T1 as the traveling distance on the uphill slope becomes longer. This enables the output control part 224 to increase the time period for which the motor 4 generates the output, as the distance of the uphill slope becomes longer. The lower the SOC of the battery 5, the more output control part 224 increases the correction amount, for example. By operating in this manner, the output control part 224 can prevent a shortage of the SOC of the battery 5 at the time T1.

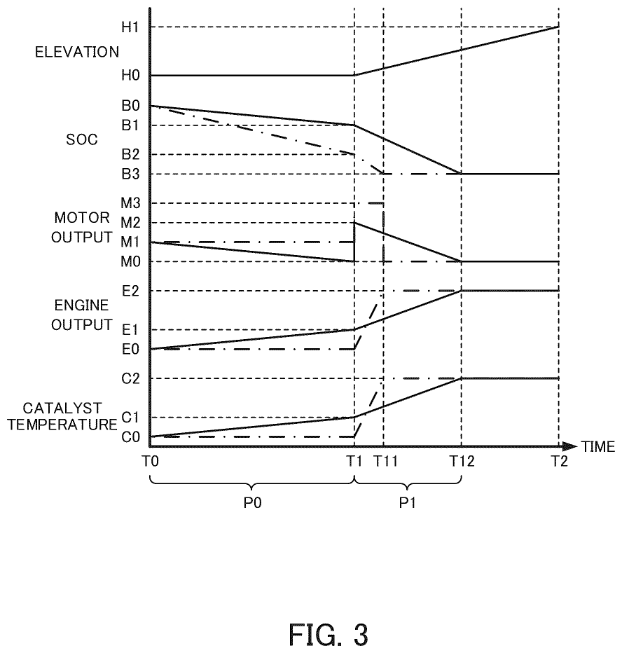

In the time period P0 shown in FIG. 2, an operation is exemplified where the engine 6 generates the first correction output E1 and the motor 4 generates the second correction output M0, but the present embodiment is not limited to this operation. The output control part 224 may change the first correction output and the second correction output with the passage of time in the time period P0. FIG. 3 shows changes in the engine output and motor output in the time period P0. In FIG. 3, the values indicated by the solid lines for the “motor output,” “engine output,” and “catalyst temperature” in the time period P0 differ from the values shown in FIG. 2, and all other aspects remain the same.

As shown in FIG. 3, for example, the output control part 224 increases the correction amount at a time prior to the time T1, which is the start timing, as the time elapsed from the time T0, which is the determination timing at which the determination part 222 determined that the vehicle S will travel on the uphill slope, increases. Specifically, the output control part 224 increases the correction amount as the time elapsed from the time T0 increases in the time period P0, thereby increasing the output of the engine 6 from the output E0 to the output E1 while reducing the output of the motor 4 from the output M1 to the output M0. By operating in this manner, the output control part 224 can suppress a rapid increase in the engine output or a rapid decrease in the motor output at the time T0. Furthermore, since the output control part 224 can reduce the amount of change in the engine output at the time T1, it can facilitate a gradual increase in the engine output.

### Processing Sequence of the Power Determination Apparatus 20

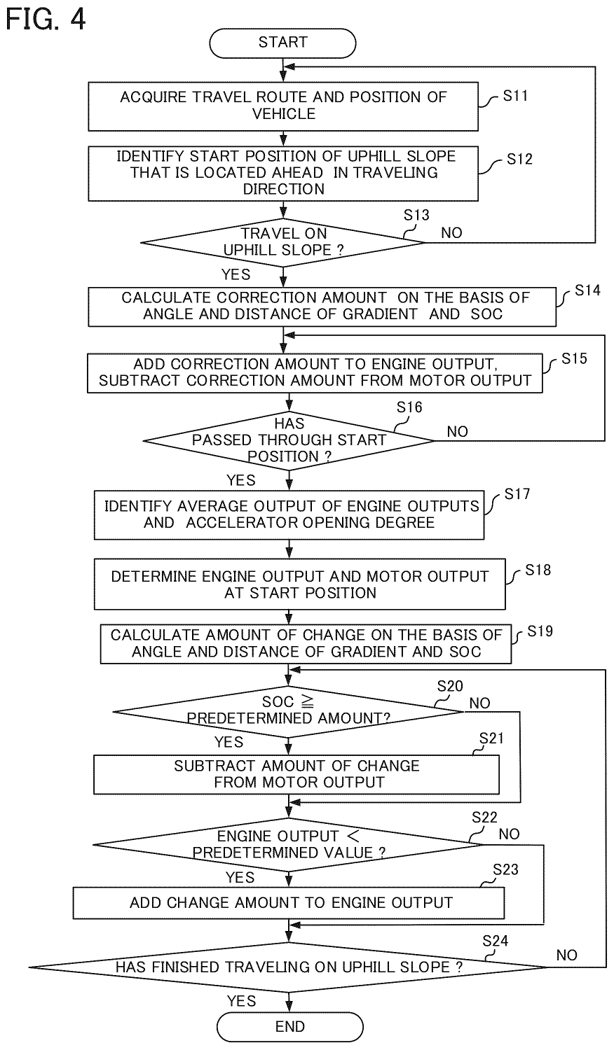

FIG. 4 shows an example of a processing sequence in the power determination apparatus 20. The processing sequence shown in FIG. 4 shows an operation of the power determination apparatus 20 determining the output of the engine 6 and the output of the motor 4 when the vehicle S, traveling on a flat road, continues to travel to the end position of the uphill slope located ahead in the traveling direction.

The acquisition part 221 acquires the travel route and the position of the vehicle S from the receiving device 1 (S11). The acquisition part 221 identifies, on the basis of the position of the vehicle S, a start position of an uphill slope that is located ahead of the vehicle S in the traveling direction and has the shortest distance from the vehicle S, from among start positions of a plurality of uphill slopes included in the traveling route of the vehicle S (S12).

The determination part 222 determines whether the vehicle S will travel on the uphill slope that includes the identified start position (S13). If a branch point exists between the start position of the uphill slope and the position of the vehicle S, the determination part 222 determines that there is a possibility the vehicle S will not travel on the uphill slope (NO in S13). Then, the power determination apparatus 20 returns to the process of step S11.

If no branch point exists between the start position of the uphill slope and the position of the vehicle S, the determination part 222 determines that the vehicle S will travel on the uphill slope (YES in S13). Then, the output control part 224 calculates a correction amount for the output on the basis of the angle and distance of the gradient included in the travel route and the SOC of the battery 5, which are acquired by the acquisition part 221 (S14).

The output control part 224 calculates a first correction output obtained by adding the calculated correction amount to the output of the engine 6 corresponding to the accelerator opening degree and the vehicle speed, and calculates a second correction output obtained by subtracting the calculated correction amount from the output of the motor 4 corresponding to the accelerator opening degree and the vehicle speed (S15).

If the detection part 223 does not detect that the vehicle S has passed the start position of the uphill slope (NO in S16), the output control part 224 returns to the process of step S15.

If the detection part 223 detects that the vehicle S has passed through the start position of the uphill slope (YES in S16), the output control part 224 calculates an average output of the outputs of the engine 6 from a time prior to the current time by a predetermined amount of time to the current time and identifies the accelerator opening degree (S17). The output control part 224 then determines the calculated average output as the output of the engine 6, and determines, as the output of the motor 4, a subtraction value obtained by subtracting the average output from the output corresponding to the accelerator opening degree (S18). Then, the output control part 224 generates the output of the engine 6 and the output of the motor 4 as determined in the process of step S18.

The output control part 224 calculates the amount of change in the output of the engine 6 and the output of the motor 4 on the basis of the angle and distance of the uphill slope, and the SOC of the battery 5, which are acquired by the acquisition part 221 (S19). If the SOC of the battery 5 is equal to or greater than a predetermined amount (YES in S20), the output control part 224 subtracts the amount of change from the motor output at a time prior to the current time by the control cycle (S21), and determines, as the motor output at the current time, a subtraction value obtained by subtracting the amount of change from said motor output. The predetermined amount is an amount greater than or equal to 0 and less than the maximum value of the motor output. If the SOC of the battery 5 is less than the predetermined amount (NO in S20), the output control part 224 determines the motor output at a time prior to the current time by the control cycle as the motor output at the current time, without subtracting the amount of change from the motor output, and proceeds to step S22.

If the engine output at the time prior to the current time by the control cycle is less than a predetermined value (YES in S22), the output control part 224 adds the change amount to the engine output (S23), and determines, as the engine output at the current time, an addition value obtained by adding the change amount to the engine output. The predetermined value is an output corresponding to the accelerator opening degree. If the engine output at the time prior to the current time by the control cycle is equal to or greater than the predetermined value (NO in S22), the output control part 224 determines the engine output at the time prior to the current time by the control cycle as the engine output at the current time, and proceeds to step S24. Then, the output control part 224 causes the engine 6 to generate the determined engine output, and causes the motor 4 to generate the determined motor output.

The detection part 223 detects an end timing at which the vehicle S finishes traveling on the uphill slope, for example, on the basis of the end position of the uphill slope and the position of the vehicle S included in the traveling route acquired by the acquisition part 221 (S24). If the detection part 223 does not detect the end timing, that is, if the vehicle S has not finished traveling on the uphill slope (NO in S24), the power determination apparatus 20 repeats the processes from step S20 to step S23. If the detection part 223 detects the end timing, that is, if the vehicle S has finished traveling on the uphill slope (YES in S24), the power determination apparatus 20 ends the process.

### Modification Example

In the above description, the operation in which the output control part 224 determines the correction amounts for the outputs of the engine 6 and the motor 4 in the time period from the determination timing at which the determination part 222 determines that the vehicle S will travel on the uphill slope to the start timing at which the vehicle S passes through the start position of the uphill slope is described, but the present embodiment is not limited to this. The output control part 224 may determine the first correction output and the second correction output by correcting the ratio (distribution) between the output of the engine 6 and the output of the motor 4 within the required output corresponding to the driving force required of the vehicle S.

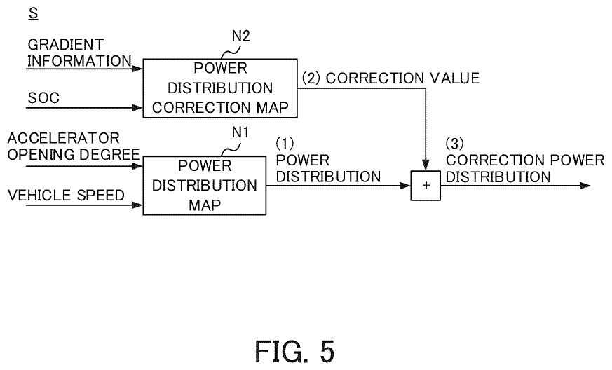

FIG. 5 shows an operation of correcting a ratio of outputs between the engine 6 and the motor 4. FIG. 5 shows the power distribution map N1 and a power distribution correction map N2, which are stored in the storage part 21. The power distribution map N1 indicates the distribution (ratio of required outputs) between the output of the engine 6 and the output of the motor 4 corresponding to the accelerator opening degree and the vehicle speed. The power distribution correction map N2 indicates correction values for the distribution of the output of the engine 6 and the output of the motor 4 based on gradient information and the SOC of the battery 5. The gradient information includes the angle and distance of the gradient, which are acquired by the acquisition part 221. The power distribution correction map N2 indicates correction values for increasing the output of the engine 6 and decreasing the output of the motor 4 as the angle and distance of the gradient increase and the SOC of the battery 5 decreases.

By referencing the power distribution map N1 stored in the storage part 21, the output control part 224 identifies a distribution (power distribution) between the output of the engine 6 and the output of the motor 4 corresponding to the accelerator opening degree and the vehicle speed ((1) shown in FIG. 5). By referencing the power distribution correction map N2 stored in the storage part 21, the output control part 224 identifies a correction value corresponding to the angle and distance of the gradient, and the SOC of the battery 5 ((2) shown in FIG. 5). The output control part 224 determines a correction power distribution obtained by adding the correction value to the power distribution ((3) shown in FIG. 5), and determines the output of the engine 6 and the output of the motor 4 corresponding to the determined correction power distribution.

For instance, the output control part 224 identifies an engine output of “0.6” and a motor output of “0.4” as the power distribution, and identifies “0.2” as the correction value. The output control part 224 then sets, as the correction power distribution of the engine output, the addition value “0.8”, which is obtained by adding the correction value “0.2” to the power distribution “0.6” of the engine output, and identifies the power distribution “0.4” of the motor output as the correction power distribution of the motor output. In other words, the output control part 224 causes the engine 6 to generate two thirds of the output corresponding to the required driving force, and causes the motor 4 to generate one third of the output corresponding to the required driving force.

By operating in this manner, the output of the engine 6 and the output of the motor 4 can be determined on the basis of the angle and distance of the gradient of the road on which the vehicle S travels, and the SOC of the battery 5, without requiring the determination part 222 to determine whether the vehicle S will travel on an uphill slope. It should be noted that in a case where the determination part 222 has determined that the vehicle S will not travel on an uphill slope, the output control part 224 may determine the outputs of the engine 6 and the motor 4 by referencing the power distribution map N1. On the other hand, in a case where the determination part 222 has determined that the vehicle S will travel on an uphill slope, the output control part 224 may determine the outputs of the engine 6 and the motor 4 by referencing both the power distribution map N1 and the power distribution correction map N2.

### Effects of the Vehicle S

As described above, the vehicle S includes the detection part 223 that detects the start timing at which the vehicle S passes through the start position of the uphill slope, and the output control part 224 that increases the output of the engine 6 and decreases the output of the motor 4 as the time elapsed from the start timing increases. By configuring the vehicle S in this manner, the vehicle S can gradually increase the output of the engine 6 while generating an output corresponding to the required driving force in traveling on a road with an uphill slope. As a result, since the vehicle S can suppress a rapid rise in the temperature of the catalyst 9 due to a rapid increase in the output of the engine 6, it is possible to suppress the ammonia adsorbed on the catalyst 9 from being desorbed and emitted.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

What is claimed is:

1. A hybrid vehicle that comprises an engine and a motor as drive sources, the hybrid vehicle comprising:
a detection part that detects a start timing at which the hybrid vehicle passes through a start position of an uphill slope; and
an output control part that increases an output of the engine and decreases an output of the motor as a time elapsed from the start timing increases.

2. The hybrid vehicle according to claim 1, wherein
the output control part increases the output of the engine by a predetermined change amount, taking an output corresponding to an accelerator opening degree as a maximum value, at the time elapsed from the start timing, and
reduces the output of the motor by the predetermined change amount so that an output obtained by subtracting the output of the engine from the output corresponding to the accelerator opening degree becomes the output of the motor.

3. The hybrid vehicle according to claim 2, wherein
the output control part determines the predetermined change amount on the basis of (i) a state of charge stored in a power storage device that supplies electricity to the motor and (ii) the angle of the uphill slope, both measured at the start timing.

4. The hybrid vehicle according to claim 3, wherein
the output control part reduces the predetermined change amount as the angle of the uphill slope increases.

5. The hybrid vehicle according to claim 3, wherein
the output control part reduces the predetermined change amount as the state of charge increases.

6. The hybrid vehicle according to claim 3, wherein
the output control part determines the predetermined change amount so that the state of charge is reduced to 0 while the hybrid vehicle travels on the uphill slope.

7. The hybrid vehicle according to claim 1, wherein
the output control part determines the output of the engine and the output of the motor at the start timing on the basis of (i) an average output of the engine in a time period from the time prior to the start timing by a predetermined time to the start timing and (ii) an accelerator opening degree at the start timing.

8. The hybrid vehicle according to claim 7, wherein
the output control part determines the average output as the output of the engine at the start timing, and determines an output obtained by subtracting the average output from an output corresponding to the accelerator opening degree at the start timing as the output of the motor at the start timing.

9. The hybrid vehicle according to claim 1, further comprising:
a determination part that determines that the hybrid vehicle will travel on the uphill slope when no branch point of a road exists between the position of the hybrid vehicle and the start position at a time prior to the start timing.

10. The hybrid vehicle according to claim 9, wherein
the output control part causes the engine to generate a first correction output obtained by adding a correction amount to the output of the engine corresponding to the accelerator opening degree and the vehicle speed, and causes the motor to generate a second correction output obtained by subtracting the correction amount from the output of the motor corresponding to the accelerator opening degree and the vehicle speed, at a time prior to the start timing as a result of the determination part determining that the vehicle will travel on the uphill slope.

11. The hybrid vehicle according to claim 10, wherein
the output control part increases the correction amount at a time prior to the start timing as the time elapsed from a determination timing, at which the determination part determined that the vehicle will travel on the uphill slope increases.

12. The hybrid vehicle according to claim 10, wherein
the steeper the angle of the uphill slope, the more the output control part increases the correction amount.

13. The hybrid vehicle according to claim 10, wherein
the longer a distance of the uphill slope, the more the output control part increases the correction amount.

14. The hybrid vehicle according to claim 1, wherein
the detection part detects, as the start timing, a timing at which a subtraction value, obtained by subtracting a second accelerator opening degree at a time prior to the current time by a predetermined time from a first accelerator opening degree at the current time, is equal to or greater than a predetermined value.
